(19) United States
(12) Patent Application Publication
(10) Pub. No.: US 2016/0210609 A1
(43) Pub. Date: Jul. 21, 2016

(54) VIRTUAL PREPAID INSTRUMENT TRANSACTIONS

(71) Applicant: Galileo Processing, Inc., Salt Lake City, UT (US)

(72) Inventor: T. Clay Wilkes, North Salt Lake, UT (US)

(21) Appl. No.: 15/003,691

(22) Filed: Jan. 21, 2016

Related U.S. Application Data
(60) Provisional application No. 62/106,208, filed on Jan. 21, 2015.
(60) Provisional application No. 62/157,169, filed on May 5, 2015.
(60) Provisional application No. 62/157,182, filed on May 5, 2015.
(60) Provisional application No. 62/157,199, filed on May 5, 2015.

(51) Int. Cl. G06Q 20/28; G06Q 20/40

(52) U.S. Cl. CPC G06Q 20/28; G06Q 20/401

(57) ABSTRACT

Some embodiments may include various aspects of a virtual prepaid instrument. Some embodiments may include methods and systems for enrolling a merchant with a virtual prepaid instrument. Some embodiments may include methods and systems for authorizing a virtual prepaid instrument transaction. Some embodiments may include methods and systems for associating a user with a virtual prepaid instrument. In some embodiments, a single user and/or multiple merchants may be associated with a personal account number for a virtual prepaid instrument.

### FIELD

This disclosure relates generally to virtual prepaid instrument transactions.

### BACKGROUND

Mobile wallets (e.g., Apple Pay or Google Wallet) have recently been adopted by consumers and merchants for use with existing credit cards and debit cards. These mobile wallets can allow consumers to use credit or debit cards electronically such as, for example, through a near field communication device.

### SUMMARY

Some embodiments include a method for collecting merchant information for use with a virtual prepaid instrument. The method, for example, may include creating a primary account number for a merchant data collection; communicating the primary account number to the merchant; receiving a first transaction message from the merchant through an open-loop financial transaction network, wherein the first transaction message includes a first plurality of transaction data including at least two of the following: the primary account number, a first merchant ID, a first merchant description, a first application identifier, a first acquiring bank identifier, and a first merchant category code; storing the first plurality of transaction data in the database in association with the merchant; receiving a second transaction message from the merchant through the open-loop financial transaction network, wherein the second transaction message includes a second plurality of transaction data including at least two of the following: the primary account number, a second merchant ID, a second merchant description, a second application identifier, a second acquiring bank identifier, and a second merchant category code; and storing the second plurality of transaction data in the database in association with the merchant.

In some embodiments, the method may also include creating a transaction card with the primary account number, and wherein communicating the primary account number to the merchant further comprises sending the transaction card to the merchant. In some embodiments, the method may also include receiving the merchant information through the Internet. In some embodiments, the method may also include creating a virtual prepaid instrument ID; and storing the virtual prepaid instrument ID in the database with the merchant ID, the merchant description, and the merchant category code.

In some embodiments, the merchant information may include at least one of a merchant name, an image, an icon, and text; the method further comprising creating a virtual prepaid instrument associated with the merchant and having a graphic including at least one of the merchant name, the image, the icon, and the text. In some embodiments, the plurality of transaction data includes a transaction amount; and the method may also include confirming the transaction amount with the merchant.

A transaction processing system for enrolling a merchant with a virtual prepaid instrument is disclosed. The transaction processing system further includes a database; a network interface; and a processor coupled with the database and the network interface. In some embodiments, the transaction processing system may be configured to create a primary account number for merchant data collection; communicate the primary account number to a merchant via the network interface; receive a first transaction message from the merchant through an open-loop financial transaction network, wherein the first transaction message includes a first plurality of transaction data including at least two of the following: the primary account number, a first merchant ID, a first merchant description, a first application identifier, a first acquiring bank identifier, and a first merchant category code; store the first plurality of transaction data in the database in association with the merchant; receive a second transaction message from the merchant through the open-loop financial transaction network, wherein the second transaction message includes a second plurality of transaction data including at least two of the following: the primary account number, a second merchant ID, a second merchant description, a second application identifier, a second acquiring bank identifier, and a second merchant category code; and store the second plurality of transaction data in the database in association with the merchant.

In some embodiments, the processor may also be configured to create a transaction card with the primary account number. In some embodiments, the processor may also be configured the processor is further configured to receive the merchant information through the Internet.

In some embodiments, the merchant information includes at least one of a merchant name, an image, an icon, and text; the method further comprising creating a virtual prepaid instrument associated with the merchant and having a graphic including at least one of the merchant name, the image, the icon, and the text.

In some embodiments, the plurality of transaction data includes a transaction amount; and the processor is further configured to confirm the transaction amount with the merchant.

In some embodiments, the processor may also be configured to create a virtual prepaid instrument ID; and store the virtual prepaid instrument ID in the database with the merchant ID, the merchant description, and the merchant category code.

Some embodiments include a method for collecting merchant data in association with a virtual prepaid instrument. The method, for example, may include creating a merchant identifier that identifies a specific merchant; creating; sending a merchant a PAN that is used for merchant data collection purposes; receiving a first transaction message from the merchant through an open-loop financial transaction network, wherein the first transaction message the primary account number, a first merchant ID, a first merchant description, and a first merchant category code; storing the first merchant ID, the first merchant description, and the first merchant category code in the database in association with the merchant identifier; receiving a second transaction message from the merchant through the open-loop financial transaction network, wherein the second transaction message includes the primary account number, a second merchant ID, a second merchant description, and a second merchant category code; storing the second plurality of transaction data in the database in association with the merchant identifier; receiving a third transaction message through the open-loop financial transaction network wherein the third transaction message includes a second primary account number, a third merchant ID, a third merchant description, and a third merchant category code; and determining whether the transaction message originated from the merchant based on comparison of one or more of the third merchant ID, the third merchant description, and the third merchant category code with the database.

A method is disclosed to authorize a virtual prepaid instrument. The method may include receiving a transaction message from a merchant through an open-loop financial transaction network, wherein the transaction message includes data elements comprising a primary account number, a transaction amount, a merchant ID, a merchant description, a mobile wallet ID, and a merchant category code; determining whether the primary account number is associated with a virtual prepaid instrument associated with the merchant based on at least one of the merchant ID, the merchant description, and the merchant category code; in the event that the primary account number is associated with a virtual prepaid instrument associated with the merchant, determining whether the transaction amount is less than an available value amount of the virtual prepaid instrument associated with the primary account number; and in the event that the transaction amount is less than an available value amount of the virtual prepaid instrument, sending a transaction authorization message response to the merchant through an open-loop financial transaction network.

In some embodiments, the determining whether the primary account number is associated with a virtual prepaid instrument associated with the merchant based on at least one of the merchant ID, the merchant description, and the merchant category code, further comprises determining whether the primary account number is associated with a virtual prepaid instrument associated with the merchant based on each of the merchant ID, the merchant description, and the merchant category code.

In some embodiments, the determining whether the primary account number is associated with a virtual prepaid instrument associated with the merchant based on at least one of the merchant ID, the merchant description, and the merchant category code, further comprises determining whether the merchant category code matches an approved merchant category code.

In some embodiments, the determining whether the primary account number is associated with a virtual prepaid instrument associated with the merchant based on at least one of the merchant ID, the merchant description, and the merchant category code, further comprises determining whether the merchant ID matches an approved merchant ID.

In some embodiments, the determining whether the primary account number is associated with a virtual prepaid instrument associated with the merchant based on at least one of the merchant ID, the merchant description, and the merchant category code, further comprises determining whether the merchant description includes at least one keyword that matches one or more approved merchant keywords.

In some embodiments, the method may also include settling the transaction with the merchant; and decrementing the transaction amount from the virtual prepaid instrument associated with the primary account number.

A transaction processing system for authorizing a virtual prepaid instrument is disclosed. The transaction processing system may include a database comprising a plurality of primary account numbers, each primary account number associated with a plurality of merchant data associated with different merchants; a network interface coupled with an open-loop financial transaction network; and a processor coupled with the database and the network interface. In some embodiments, the processor may be configured to receive a transaction message from a merchant through the open-loop financial transaction network via the network interface, wherein the transaction message includes data elements comprising a primary account number, a transaction amount, and merchant data; determine whether the primary account number is associated with a virtual prepaid instrument associated with the merchant based on the merchant data; in the event that the primary account number is associated with a virtual prepaid instrument associated with the merchant, determine whether the transaction amount is less than an available value amount of the virtual prepaid instrument associated with the primary account number; and in the event that the transaction amount is less than an available value amount of the virtual prepaid instrument, send a transaction authorization message response to the merchant through the open-loop financial transaction network.

In some embodiments, the merchant data may include one or more of a merchant ID, a merchant description, and a merchant category code.

In some embodiments, to determine whether the primary account number is associated with a virtual prepaid instrument associated with the merchant based on the merchant data, the processor is further configured to determine whether the primary account number is associated with a virtual prepaid instrument associated with the merchant based on each of the merchant data.

In some embodiments, to determine whether the primary account number is associated with a virtual prepaid instrument associated with the merchant based on the merchant data, the processor is further configured to determine whether the merchant category code matches an approved merchant category code.

In some embodiments, to determine whether the primary account number is associated with a virtual prepaid instrument associated with the merchant based on the merchant data, the processor is further configured to determine whether the merchant ID matches an approved merchant ID.

In some embodiments, to determine whether the primary account number is associated with a virtual prepaid instrument associated with the merchant based on the merchant data, the processor is further configured to determine whether the merchant description includes at least one keyword that matches one or more approved merchant keywords.

In some embodiments, the transaction processing system may be further configured to settle the transaction with the merchant; and decrement the transaction amount from the virtual prepaid instrument associated with the primary account number and the merchant.

A method for authorizing a virtual prepaid instrument is disclosed. The method may include receiving at a virtual prepaid instrument processor a transaction message from a merchant through an open-loop financial transaction network, wherein the transaction message includes data elements comprising a primary account number, a transaction amount, a merchant ID, and a merchant category code; determining whether the merchant category code corresponds with an approved merchant category code; determining whether the merchant ID corresponds with an approved merchant ID; determining whether the primary account number and the merchant ID are associated with a virtual prepaid instrument; determining a value associated with the primary account number and the merchant; determining whether the transaction amount is less than the value; and sending a transaction authorization message response to the merchant through an open-loop financial transaction network.

In some embodiments, the data elements may include a merchant description. In some embodiments, the method may include determining whether the merchant description corresponds with a merchant description associated with a merchant. In some embodiments, the method may include settling the transaction with the merchant; and decrementing the transaction amount from the virtual prepaid instrument associated with the primary account number and the merchant.

A method for enrolling a merchant virtual prepaid instrument is disclosed. The method may include receiving merchant information comprising a graphic, a merchant name, and merchant transaction data; creating a visual representation of a virtual prepaid instrument that includes at least a portion of the graphic and the merchant name; providing the visual representation of the virtual prepaid instrument to users in a virtual prepaid instrument marketplace that includes a plurality of visual representations of virtual prepaid instruments; receiving a request to purchase the virtual prepaid instrument from a first user for a second user, the purchase request comprising a received value; determining a primary account number associated with the second user; associating the virtual prepaid instrument, the primary account number, and the received value; and sending a visual representation of the virtual prepaid instrument to the second user with a requested value.

In some embodiments, the method may include creating an account in a database for the primary account number. In some embodiments, the first user and the second user are the same user. In some embodiments, the first user and the second user are different users, and wherein the purchase request comprises contact information for the second user. In some embodiments, the merchant transaction data comprises at least one of a merchant ID, a merchant description, and a merchant category code. In some embodiments, the method may include associating at least a portion of the merchant transaction data with the virtual prepaid instrument account in a database. In some embodiments, the primary account number comprises a sixteen digit number or a nineteen digit number.

In some embodiments, determining a primary account number associated with the user comprises determining whether the user is associated with a primary account number; and in the event that the user is not associated with a primary account number, creating a primary account number for the user. In some embodiments, graphic and the merchant name may be received from the merchant through a webpage. In some embodiments, the merchant transaction data is received from the merchant through an open-loop transaction network. In some embodiments, the method may include settling a transaction for the virtual prepaid instrument with the user for the transaction amount.

A system for enrolling a merchant virtual prepaid instrument is disclosed. The system may include a database; a network interface; a processor coupled with the database and the network interface. The processor may be configured to receive merchant information comprising a graphic, a merchant name, and merchant transaction data; create a visual representation of a virtual prepaid instrument that includes at least a portion of the graphic and the merchant name; provide the visual representation of the virtual prepaid instrument to users in a virtual prepaid instrument marketplace that includes a plurality of visual representations of virtual prepaid instruments; receive a request to purchase the virtual prepaid instrument from a first user for a second user, the purchase request comprising a received value; determine a primary account number associated with the second user; associate the virtual prepaid instrument, the primary account number, and the received value; and send a visual representation of the virtual prepaid instrument to the second user with a requested value.

In some embodiments, the processor may be configured to create an account in the database for the primary account number. In some embodiments, the first user and the second user are the same user. In some embodiments, the first user and the second user are different users, and wherein the purchase request comprises contact information for the second user. In some embodiments, the merchant transaction data comprises at least one of a merchant ID, a merchant description, and a merchant category code. In some embodiments, the processor is further configured to associate at least a portion of the merchant transaction data with the virtual prepaid instrument account in the database. In some embodiments, the primary account number comprises a sixteen digit number or a nineteen digit number.

In some embodiments, to determine a primary account number associated with the user, the processor is configured to determine whether the user is associated with a primary account number; and in the event that the user is not associated with a primary account number, create a primary account number for the user.

In some embodiments, the graphic and the merchant name may be received from the merchant through a webpage. In some embodiments, the merchant transaction data is received from the merchant through an open-loop transaction network. In some embodiments, the processor is further configured to settle a transaction for the virtual prepaid instrument with the user for the transaction amount.

These illustrative embodiments are mentioned, not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1A is a block diagram of a system that may be used for authorizing and/or settling virtual prepaid instrument transactions.

FIG. 1B is another block diagram of a system that may be used for authorizing and/or settling virtual prepaid instrument transactions.

FIG. 1C is another block diagram of a system that may be used for authorizing and/or settling virtual prepaid instrument transactions.

FIG. 1D is another block diagram of a system that may be used for authorizing and/or settling virtual prepaid instrument transactions.

FIG. 2A illustrates an example table of virtual prepaid instrument holders associated with different PANs.

FIG. 2B illustrates an example PAN-merchant table.

FIG. 3 is a flowchart of an example process of transaction proceeding through the system shown in FIG. 1A.

FIG. 4 is a flowchart of an example process for approving a virtual prepaid instrument transaction, according to some embodiments.

FIG. 5 illustrates an example merchant table.

FIG. 6 is a flowchart of an example process for creating a virtual prepaid instrument for a merchant.

FIG. 7 is a flowchart of an example process for creating a merchant branded virtual prepaid instrument.

FIG. 8 illustrates an example screenshot of a mobile wallet that includes a plurality of virtual prepaid instruments.

FIG. 9 illustrates an example screenshot of a virtual prepaid instrument for a merchant.

FIG. 10 is a flowchart of an example process for transferring a specific value from a merchant branded virtual prepaid instrument held by a first user to a second user.

FIG. 11 is a flowchart of an example process for authorizing a virtual prepaid instrument transaction.

FIG. 12 is a block diagram of a marketplace.

FIG. 13 is a block diagram of an illustrative computational system for performing functionality to facilitate implementation of embodiments described herein.

### DETAILED DESCRIPTION

Embodiments of the invention provide improvements to various aspects of digital transaction processing. For example, some embodiments implement improvements in transaction processing of mobile payments, e-gift cards, virtual prepaid instruments, and/or digital stored value cards. Mobile wallets (e.g., Apple Pay or Google Wallet) are being adopted by consumers and merchants for use with existing credit and debit cards for payment at various locations. These mobile wallets, however, do not provide a mechanism for virtual prepaid instruments to operate in financial networks such as an open-loop network. These problems are unique to mobile wallets and/or virtual prepaid instruments.

Some embodiments are described in conjunction with virtual prepaid instruments such as, for example, a virtual stored value card, an e-gift card, a digital prepaid card, virtual a reloadable card, etc. Some embodiments may extend to other transaction cards whether digital or physical. For example, some embodiments may extend to mobile credit cards, mobile debit cards, credit cards, debit cards, etc.

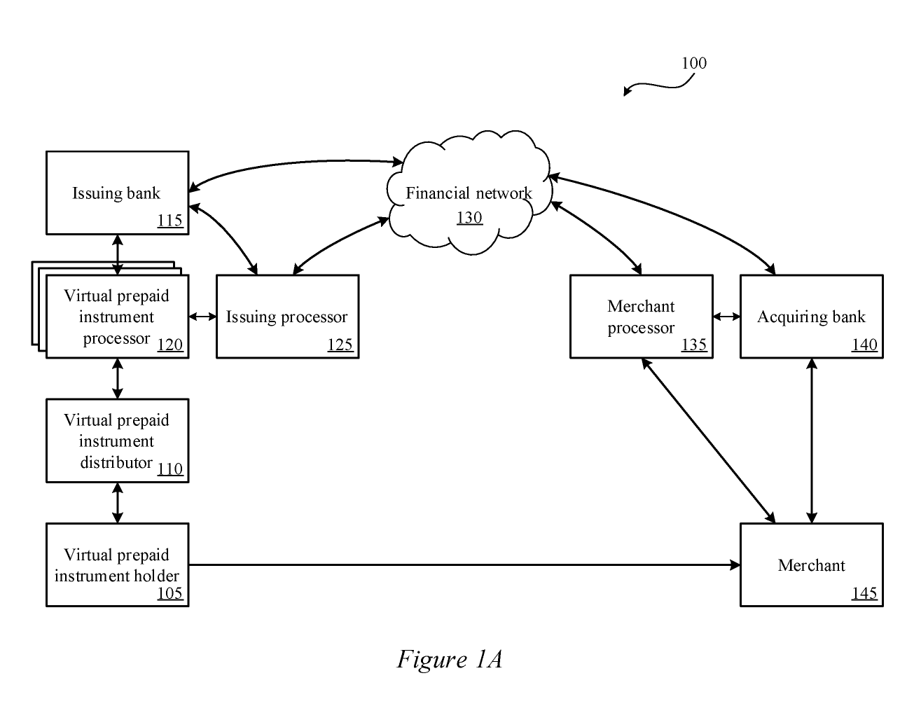

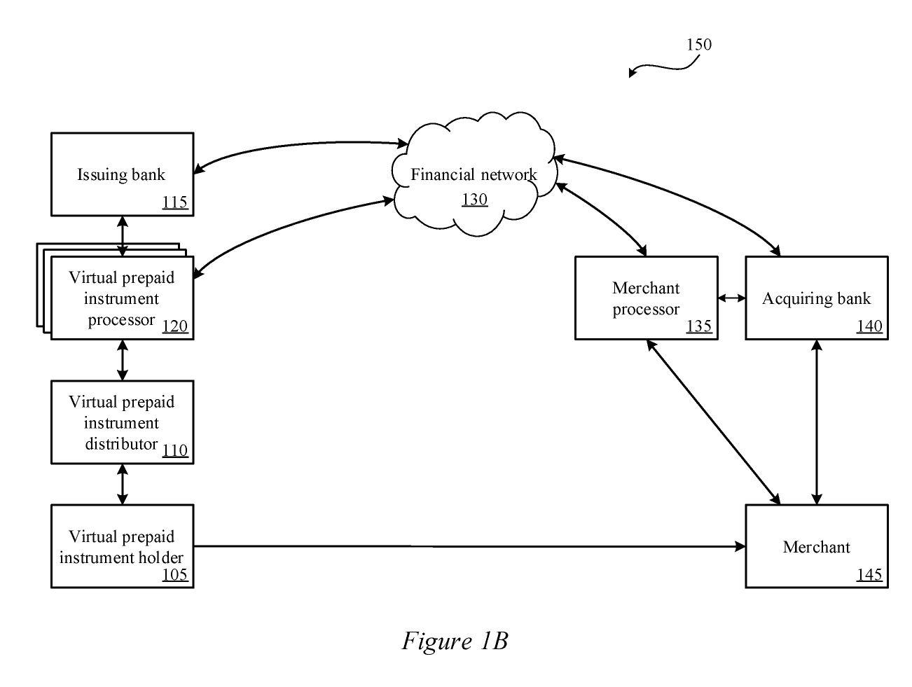

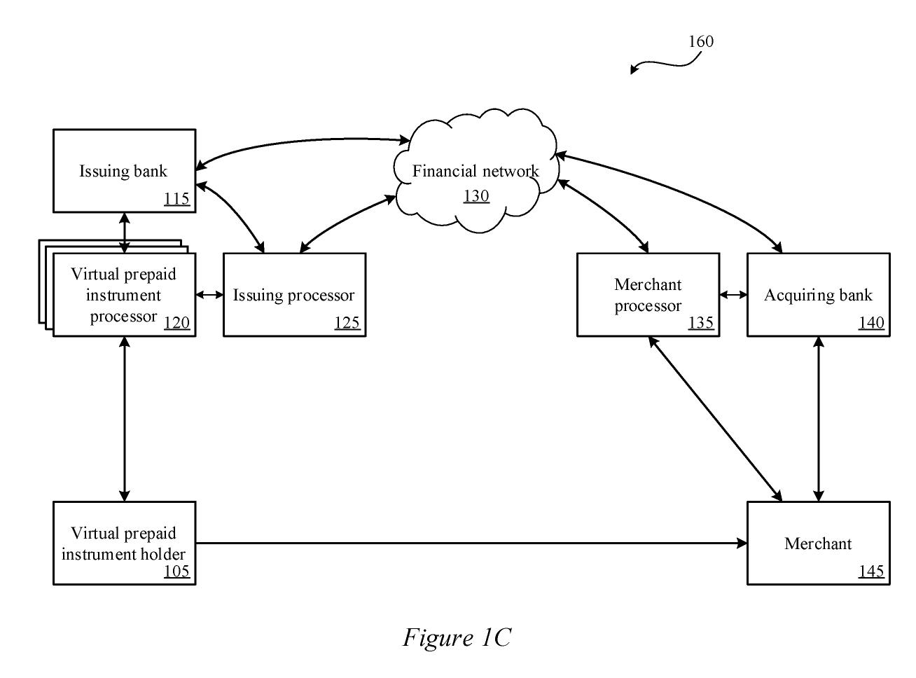

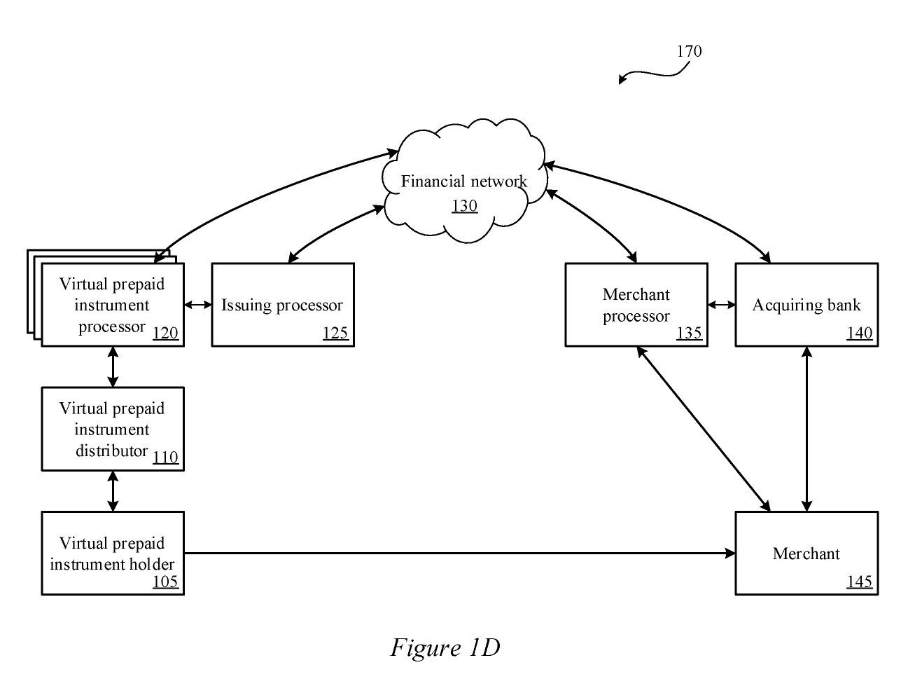

FIG. 1A is a block diagram of a system 100 that may be used for authorizing and/or settling virtual prepaid instrument transactions. The system 100 may include a number of components that may be operated by different organizations and/or companies. In some embodiments, the system 100 includes components of an open-loop payment processing system and/or a closed loop payment processing system.

The virtual prepaid instrument holder 105 may be a consumer device that executes software and/or algorithms that represent a prepaid instrument among other transaction devices such as debit cards and/or credit cards. In some embodiments, the consumer device may be a smart device may include a mobile wallet that may include a representation of one or more credit cards, debit cards, prepaid, cards, gift cards, etc. In some embodiments, the consumer device may be a smartphone, a tablet, a watch, a mobile phone, a laptop, a computer, a car interface, etc. or any other user device.

In some embodiments, a virtual prepaid instrument may be represented as an icon, text, and/or graphics on the consumer's smart device. In some embodiments, the virtual prepaid instrument may be held in a mobile wallet on the consumer's smart device. In some embodiments, the virtual prepaid instrument may be associated with a specific PAN (primary account number), a user id, a mobile wallet provider ID, a virtual prepaid card distributor ID, and/or a specific merchant. In some embodiments, the virtual prepaid instrument holder 105 may have more than one virtual prepaid instrument associated with different merchants but with the same PAN.

The virtual prepaid instrument holder 105 may be associated with a virtual prepaid instrument distributor 110, an issuing bank 115, and/or one or more virtual prepaid instrument processors 120. In some embodiments, the virtual prepaid instrument distributor 110, the issuing bank 115, and/or the virtual prepaid instrument processor 120 may be the same entity. In some embodiments, the issuing bank 115 and the virtual prepaid instrument processor 120 may be the same entity. In some embodiments, the issuing processor 125 and the virtual prepaid instrument processor 120 may be the same entity.

In some embodiments, the virtual prepaid instrument distributor 110 may provide a marketplace of virtual prepaid instruments provided by a plurality of merchants. In some embodiments, the virtual prepaid instrument distributor 110 may provide a marketplace of virtual prepaid instruments from which a user may purchase a virtual prepaid instrument and provide funds that may be loaded onto the virtual prepaid instrument. The marketplace may be accessible by consumers through the Internet. In some embodiments, the marketplace may be accessible by consumer using a mobile wallet application executing on the consumer's smart device. In some embodiments, the marketplace may be accessible through a webpage.

In some embodiments, the marketplace may provide a plurality of virtual prepaid instruments for one or more merchants in a webpage, display, and/or interface that a consumer may purchase for themselves or for one or more other users. The marketplace may include graphics, images, and/or text representing and/or describing the plurality of virtual prepaid instruments. An example marketplace is illustrated in FIG. 12.

In some embodiments, the virtual prepaid instrument distributor may provide a webpage, display, and/or interface where a merchant may create a virtual prepaid instrument that can be purchased through marketplace.

In some embodiments, the issuing bank 115, for example, may be used to transfer funds associated with a virtual prepaid instrument transaction to an acquiring bank 140 associated with the merchant 145 through the financial network 130. The issuing bank 115 may also respond to authorization requests from a merchant through various networks and or processors such as, for example, the financial network 130, the issuing processor 125, and/or the acquiring processor 135. The issuing bank 115 may also determine the available funds for each virtual prepaid instrument by communicating with the virtual prepaid instrument processor 120 and/or the virtual prepaid instrument distributor 110.

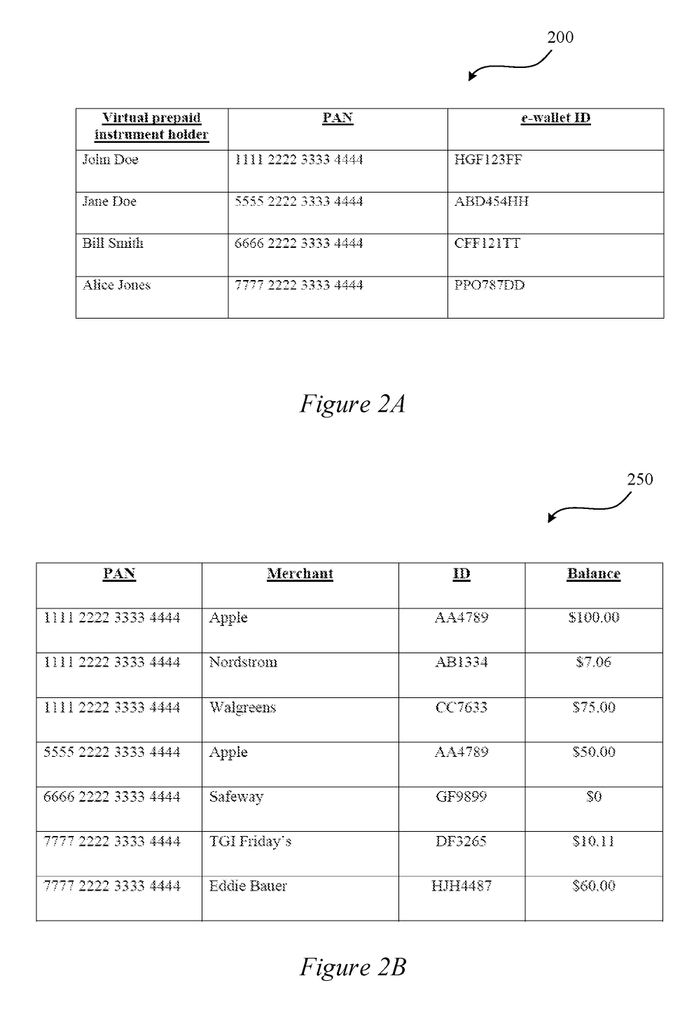

In some embodiments, the virtual prepaid instrument processor 120 may manage the accounts of the various virtual prepaid instruments held by the virtual prepaid instrument holder 105. The virtual prepaid instrument processor 120, for example, may associate a single virtual prepaid instrument holder 105, a virtual prepaid provider ID, an e-wallet ID, and/or a PAN with one or more virtual prepaid instruments and/or a database of values for each virtual prepaid instrument at a specific merchant held by the virtual prepaid instrument holder 105. These values may be the amount of funds available for the user of the virtual prepaid instrument holder 105 to spend at a specific merchant. These values may be associated together in a PAN table; an example of which is shown in FIG. 2A.

In some embodiments, the virtual prepaid instrument processor 120 may communicate account balances to the virtual prepaid instrument holder's mobile wallet on the virtual prepaid instrument holder's smart device. For example, a virtual prepaid instrument holder 105 may have a virtual prepaid instrument for the merchant 145 of $100. When the virtual prepaid instrument holder 105 makes a purchase at the merchant 145 for $50 the account at the virtual prepaid instrument processor 120 will be decremented by $50. The virtual prepaid instrument processor 120 may then send a message to the smart device of the virtual prepaid instrument holder 105 indicating that the amount of funds available at the merchant is now $50. The mobile wallet of the virtual prepaid instrument holder 105 may then indicate $50 being available at the merchant.

In some embodiments, the issuing processor 125 may be in communication with the virtual instrument processor 120, the issuing bank 115, and/or a financial network 130. The issuing processor 125 may, for example, receive authorization requests from the merchant processor 135. The issuing processor 125 may request authorization from the virtual prepaid instrument processor 120 and/or the issuing bank 115. The issuing processor 125 may communicate whether the transaction has been authorized or declined to the merchant 145.

In some embodiments, the financial network 130 may be an open-loop financial transaction network or a closed-loop financial transaction network.

Some open-loop financial transaction networks may link a customer's payment device directly to a credit or debit card. Consumers can use the payment device, subject to whatever terms and conditions the card issuer provides to the consumer. The devices can even be used outside of the event, if the terms allow, at any retailer that supports contactless payment. In some embodiments, an open-loop financial transaction network may involve multiple parties and/or may connect two financial institutions—one that issues the card to the cardholder, known as the issuing financial institution or issuer, and one that has the banking relationship with the merchant, known as the acquiring financial institution or acquirer—and manages information and the flow of value between them. Visa® and MasterCard® branded cards are examples of cards that operate on an open-loop financial transaction network.

Some closed-loop financial transaction networks allow consumers to pre-load funds onto a spending account linked to the payment device (e.g., a card or NFC enabled device). In some typical closed-loop financial transaction network, the payment services are provided directly to merchants without involving third-party payment networks.

Stored value cards, prepaid cards, or gift cards may, for example, run on a closed-loop financial network.

In some cases, cards that run on the closed-loop financial network may allow consumers to pre-load funds into a spending account that is linked to the payment device (e.g., a card or NFC enabled device). Customers can re-load amounts during an event through a variety of mechanisms, including automatic top-up.

In some embodiments, the merchant 145 may include any entity that may receive payment for goods or services. The merchant 145 may be associated with a credit card terminal such as, for example, a point-of-sale device, or a near field communication device, etc. The merchant 145 may be associated with a physical location, a mobile location, or an online store. The merchant 145 may be associated with any device that can retrieve a PAN from a virtual prepaid instrument holder 105, transaction details from the merchant 145, and/or merchant details from the merchant 145, and communicate this information to the merchant processor 135.

In some embodiments, the merchant processor 135 may request authorization for transactions by communicating transaction details to the issuing processor 125 through the financial network 130. In some embodiments, the merchant processor 135 may communicate transaction approvals and denials between the merchant processor 135 and the merchant 145. In some embodiments, the merchant processor 135 may communicate transaction details with the acquiring bank 140 for settlement purposes.

In some embodiments, the devices and/or components of system 100 may communicate via virtual links, wireless links, and/or wired links. These communication links may include, for example, radio-frequency (“RF”) links, infrared links, acoustic links, and other wireless mediums. The financial network 130 may comprise a wide area network (“WAN”), a local area network (“LAN”), the Internet, a Public Switched Telephone Network (“PSTN”), a paging network, or a combination thereof. In some embodiments, the issuing bank 115 and the processor 125 may communicate either directly or via the financial network 130. In some embodiments, the acquiring bank 140 and the merchant processor 135 may communicate either directly or via the financial network 130.

The virtual prepaid instrument processor 120 may incorporate many of the functions of other components shown in system 100.

The various components shown in FIG. 1 may include one or more servers that may or may not be distributed across a network.

FIG. 1B is another block diagram of a system 150 that may be used for authorizing and/or settling virtual prepaid instrument transactions. In this example, the issuing processor 115 shown in FIG. 1A may be incorporated within the virtual prepaid instrument processor 120. The processes, methods, steps, etc. described in conjunction with the issuing processor 115 and virtual prepaid instrument processor 120 may be performed by the virtual prepaid instrument processor 120.

FIG. 1C is another block diagram of a system 160 that may be used for authorizing and/or settling virtual prepaid instrument transactions. In this example, the virtual prepaid instrument distributor 110 shown in FIG. 1A may be incorporated within the virtual prepaid instrument processor 120. The processes, methods, steps, etc. described in conjunction with virtual prepaid instrument distributor 110 and virtual prepaid instrument processor 120 may be performed by the virtual prepaid instrument processor 120.

FIG. 1D is another block diagram of a system 170 that may be used for authorizing and/or settling virtual prepaid instrument transactions. In this example, the issuing bank 115 shown in FIG. 1A may be incorporated within the virtual prepaid instrument processor 120. The processes, methods, steps, etc. described in conjunction with issuing bank 115 and virtual prepaid instrument processor 120 may be performed by the virtual prepaid instrument processor 120.

In some embodiments, when a virtual prepaid instrument is purchased by a user, funds may transfer from the user to the merchant 145 upon purchase of the virtual prepaid instrument. For example, funds may be transferred from the issuing bank 115 to the acquiring bank 140 upon purchase of the virtual prepaid instrument.

In some embodiments, when a virtual prepaid instrument is purchased by a user, funds may transfer from the user to the merchant 145 to the virtual prepaid instrument distributor 110, the virtual prepaid instrument processor 120, and/or the issuing bank 115 upon purchase of the virtual prepaid instrument. Then, when the virtual prepaid instrument is used in a transaction with the merchant 145, funds may transfer from the virtual prepaid instrument distributor 110, the virtual prepaid instrument processor 120, and/or the issuing bank 115 to the acquiring bank.

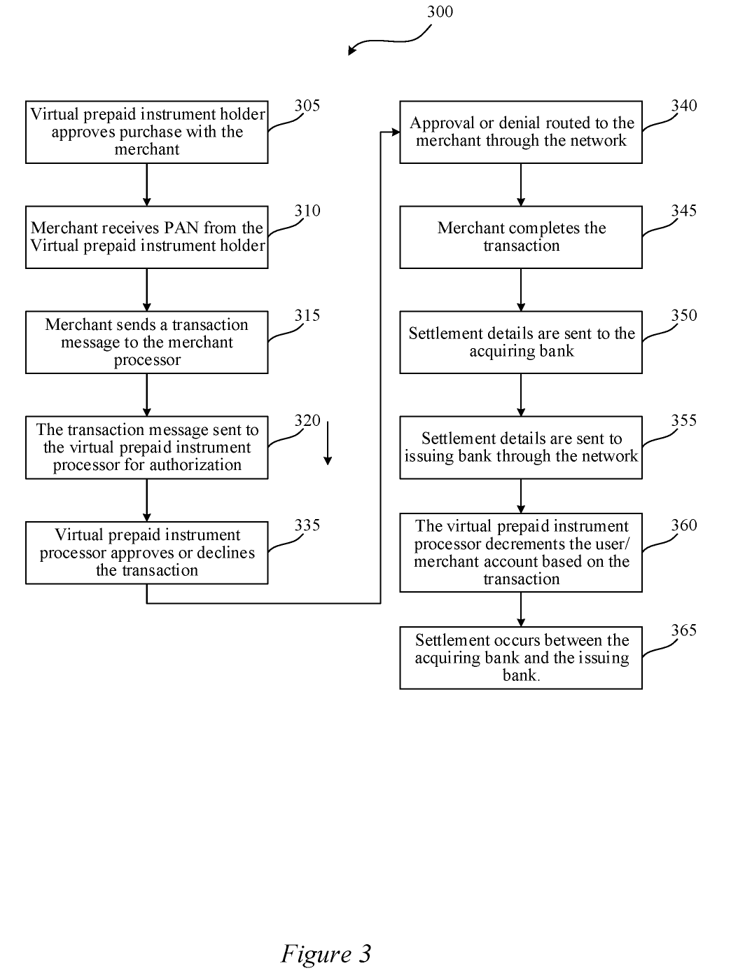

FIG. 3 is a flowchart of an example process 300 of a transaction proceeding through the system 100, according to at least one embodiment. One or more steps of the process 300 may be implemented, in some embodiments, by one or more components of the system 100. Although illustrated as discrete blocks, various blocks may be divided into additional blocks, combined into fewer blocks, or eliminated, depending on the desired implementation.

When a virtual prepaid instrument holder 105 chooses to purchase a product or service from the merchant 145, the virtual prepaid instrument holder 105 may, for example, present a virtual prepaid instrument to the merchant as payment for the product or service. The virtual prepaid instrument, for example, can be presented via a point of sale device having, for example, a near filed communication capability or a magnetic stripe reader. Alternatively or additionally, the PAN associated with the user and/or an e-wallet provider ID, for example, can be provided through a webpage or on the phone.

FIG. 2A illustrates an example PAN table 200 that associates a plurality of virtual prepaid instrument holders with different PANs. In some embodiments, the PAN table 200 may include additional data elements and/or some of the data elements may not be included. In some embodiments, the PAN table 200 may be stored as part of a database at the virtual prepaid instrument processor 120. In some embodiments the PAN table 200 may be a lookup table.

In this example, the table includes four virtual prepaid instrument holders 105 associated with four PANs. Any number of other data elements may be included in the table. The table may also include other information about each virtual prepaid instrument holder 105 such as, for example, contact information, bank information, personal identification numbers, passwords, etc.

FIG. 2B illustrates an example PAN-merchant table 250 that associates a number of PAN with different merchants, virtual prepaid instrument IDs, and a value. In some embodiments, the PAN-merchant table 250 may include additional data elements and/or some of the data elements may not be included. In some embodiments, the PAN-merchant table 250 may be stored as part of a database at the virtual prepaid instrument processor 120. In some embodiments the PAN-merchant table 250 may be a lookup table.

In this example, the PAN 1111 2222 3333 4444 is associated with three merchants: Apple, Nordstrom, and Walgreens indicating that the user associated with this PAN has virtual prepaid instruments at each of these merchants that can each be individually redeemed using the virtual prepaid instrument. Each virtual prepaid instrument 105 has a listed value or an amount available for the virtual prepaid instrument holder to use at the respective merchant. As shown in the PAN-merchant table 250, in some embodiments, some PANs may be associated with a plurality of virtual prepaid instruments or a single virtual prepaid instrument. In some embodiments, each merchant may be associated with a specific value or an amount that the virtual prepaid instrument holder 105 may use at the given merchant.

In some embodiments, the PAN may be referred to in the industry as a bank card number and/or may be the account number found on most credit cards, debit cards, and bank cards. A PAN may be governed by an industry standard, such as those made by the International Organization for Standardization/International Electrotechnical Commission (“ISO”)/(“IEC”). In some embodiments, a PAN may have a certain amount of internal structure. In some embodiments, it may share a common numbering scheme among virtual prepaid instruments.

A PAN may include a number associated with the ISO/IEC 7812 standard. The ISO/IEC 7812 standard, for example, includes various fields such as, for example, a single-digit Major Industry Identifier (“MII”), a six-digit Issuer Identification Number (“IIN”), an account number, and/or a single digit check sum calculated using the Luhn algorithm. The prefix of the PAN may be the sequence of digits at the beginning of the number that determines the credit card network to which the number belongs. In some embodiments, the first 6 digits of a PAN may be referred to as the Issuer Identification Number (“IIN”). These identify the institution that issued the card to the card holder. The rest of the number may be allocated or determined by the issuing bank 115. A PAN may include a sixteen digit number, but other multi-digit numbers as well as alphanumeric identifiers are within the scope of the invention.

FIG. 3 is a flowchart of an example process 300 for making a virtual prepaid instrument transaction using the system 100 shown in FIG. 1A. Although illustrated as discrete blocks, various blocks may be divided into additional blocks, combined into fewer blocks, or eliminated, depending on the desired implementation.

Process 300 begins at block 305 when the virtual prepaid instrument holder 105 approves a purchase of a product or service at the merchant 145. For example, the virtual prepaid instrument holder 105 may swipe a mag-stripe virtual prepaid instrument with a card reader, present a smartphone to an NFC device and select a specific virtual prepaid instrument from a mobile wallet, enter a PAN associated with the virtual prepaid instrument into an e-commerce web site, etc.

At block 310 the merchant 145 may receive the PAN from the virtual prepaid instrument holder 105. Other data may also be received such as, for example, the name or other identifying information of the virtual prepaid instrument holder 105, a PIN, a password, an e-wallet provider ID, a marketplace ID, etc.

At block 315 transaction details may be communicated to the merchant processor 135 in a transaction message. The transaction message may include a number of data elements such as, for example, one or more of a PAN data field, a PIN data field, a password data field, a merchant identifier data field, a merchant category code data field, a merchant description data field, a transaction amount data field, a terminal ID data field, etc. In some embodiments, the transaction message may be sent to a given merchant processor based on the amount of the transaction, the type of transaction, etc. For example, the merchant may send the transaction message to one merchant when the transaction has a transaction value below a given amount and send the transaction message to another merchant when the transaction has a transaction value above a given amount. As another example, the merchant may send the transaction message to one merchant based on the transaction type (e.g., whether it is a gift card transaction, a credit card transaction, or a debit card transaction, etc.). The financial network 130, for example, may determine a bank identification number (BIN) from the PAN in the transaction message and route the transaction message to the issuing processor based on the BIN.

In some embodiments, the transaction message may be any kind of digital message that communicates transaction details such as, for example, a transaction interchange message, a financial transaction card originated message, and/or a message compliant with ISO 8583, etc. In some embodiments, the format of the transaction message may comply with ISO 8583. In some embodiments, the transaction message may include one or more data fields (or data elements) similar to data fields in an ISO 8583 message. In some embodiments, the transaction message may include data derived from the card (e.g., the primary account number), the terminal (e.g., the merchant ID), the transaction (e.g., the amount), the acquirer processor (e.g., the merchant code or MCC) together with other data which may be generated dynamically or added by intervening systems. In some embodiments, the transaction message may include an additional header and/or an additional footer.

In some embodiments, the transaction message may be an authorization message response (e.g., in a dual messaging system) that requires authorization by the issuing bank 115, the virtual prepaid instrument processor 120, and/or the issuing processor 125 prior to settlement, which may occur in conjunction with a second message. In some embodiments, the transaction message may be a financial message (e.g., in a single message system) that allows for and provides details for authorization and settlement in a single message exchange.

At block 320 the merchant processor 135 may send the transaction message to the virtual prepaid instrument processor 120 through the financial network 130 for authorization. The transaction message may travel any number of paths. For example, the transaction message may travel to the virtual prepaid instrument processor 120 through the issuing processor 125. The issuing processor 125 may then route the transaction message and/or one or more transaction details within the transaction message to the issuing bank 115 and/or the virtual prepaid instrument processor 125 based on merchant information in the transaction message and/or information from the PAN. As another example, the merchant processor 135 may send the transaction message to the virtual prepaid instrument processor 125 through the financial network 130 based on the BIN of the PAN.

At block 335 the virtual prepaid instrument processor 120 may authorize or decline the transaction. In some embodiments, the virtual prepaid instrument processor 120 may determine whether the PAN is associated with a virtual prepaid instrument of the merchant 145 and/or whether there are any funds associated with a virtual prepaid instrument associated with the merchant. For example, the virtual prepaid instrument processor 120 may extract merchant information from the transaction details. Using the PAN and the merchant information, the virtual prepaid instrument processor 120 may look up the PAN in a PAN-merchant table (e.g., the PAN-merchant table 250 shown in FIG. 2B) and determine whether the merchant data listed in the PAN-merchant table is the same as or similar with the merchant information extracted from the transaction details.

For example, the virtual prepaid instrument processor 120 may decline the transaction if it is determined that the PAN in the transaction details is not in the PAN-merchant table. As another example, the virtual prepaid instrument processor 120 may decline the transaction if it is determined that the merchant data in the transaction data is not associated with a merchant in the PAN-merchant table. As another example, the virtual prepaid instrument processor 120 may decline the transaction if an e-wallet ID in the transaction message does not match the e-wallet ID associated with the PAN stored in a database (e.g., the PAN database). As another example, the virtual prepaid instrument processor 120 may decline the transaction if it is determined that the funds associated with the merchant 145 in the PAN-merchant table is less than the amount of the transaction. For example, the virtual prepaid instrument processor 120 may approve the transaction if there are sufficient funds associated with the merchant in the PAN-merchant table.

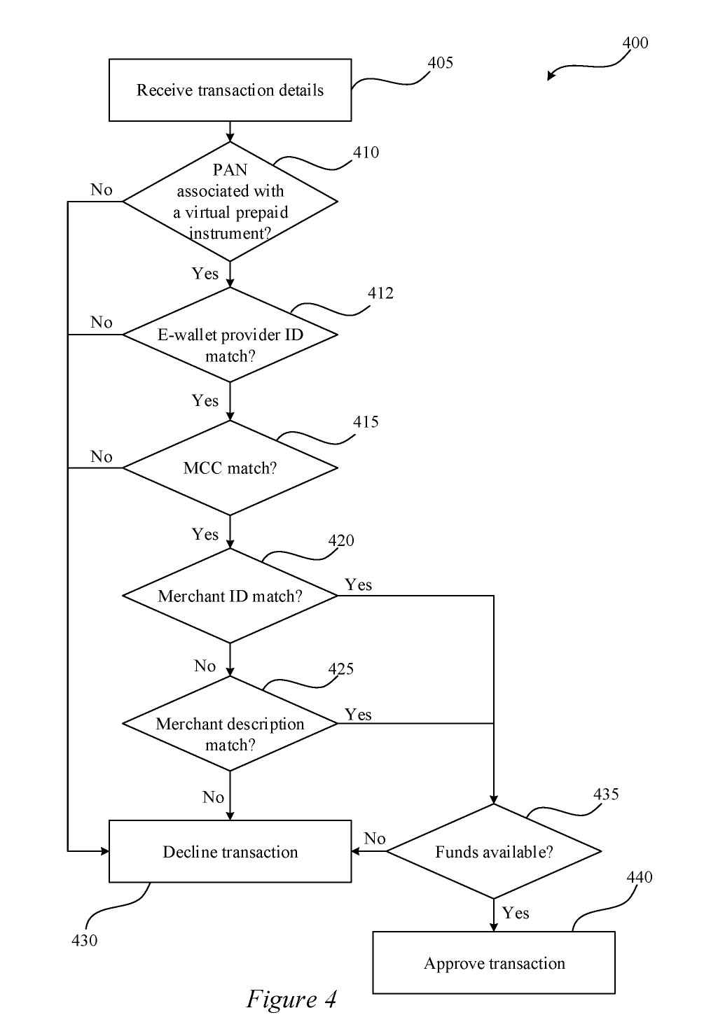

Block 335, for example, may include one or more steps of process 400 shown in FIG. 4.

At block 340, an authorization message or a decline message (e.g., an authorization message response) may be routed to the merchant 145 through the issuing processor 125, the financial network 130, and/or the merchant processor 135. If the transaction was declined, then the process 300 may, for example, end after block 340. In some embodiments, if the transaction was declined, then the return message may indicate the amount of funds available, if any.

At block 345, if the transaction was approved, the merchant may complete the transaction. At block 350 settlement details may be sent to the acquiring bank 140. The settlement details may indicate the transaction amount, the PAN, etc. In some embodiments, the settlement details may be sent to the acquiring bank 140 through the merchant processor 135. At block 355 the settlement details may be sent to the issuing bank 115 through the financial network 130. In some embodiments, the transaction may be part of a dual message system and a file exchange may be required to finalize settlement. In some embodiments, the transaction may be part of a single message system and the settlement may not require an additional file exchange for settlement.

At block 360 the virtual prepaid instrument processor 120 may decrement the amount of the transaction from the account associated with the PAN and the merchant 145. In some embodiments, the virtual prepaid instrument processor 120 may send a message to the virtual prepaid instrument holder's device that indicates that the account associated with the merchant has been decremented.

At block 365 the acquiring bank 140 and the issuing bank 115 may settle using open-loop settlement practices. In some embodiments, the virtual prepaid instrument processor 120 and/or the issuing bank 115 may settle the transaction.

FIG. 4 is a flowchart of an example process 400 for approving a virtual prepaid instrument transaction, according to some embodiments. One or more steps of the process 400 may be implemented, in some embodiments, by one or more components of the system 100 of FIG. 1A, such as the virtual prepaid instrument processor 120 of FIG. 1A. Although illustrated as discrete blocks, various blocks may be divided into additional blocks, combined into fewer blocks, or eliminated, depending on the desired implementation.

The process 400 begins at block 405. At block 405, transaction details (e.g., in a transaction message) may be received at the virtual prepaid instrument processor 120. The transaction details may include, for example, a transaction amount, a PAN, a merchant category code (MCC), a merchant ID (MID), e-wallet provider ID, a merchant description, etc.

At block 410 it may be determined whether the PAN is associated with a virtual prepaid instrument. For example, the PAN-merchant table may be searched to determine whether the PAN is associated with a virtual prepaid instrument. If the PAN is not associated with a virtual prepaid instrument, then process 400 may proceed to block 430 where the transaction is declined. If the PAN is associated with a virtual prepaid instrument, then process 400 may proceed to block 412.

At block 412 it may be determined whether an e-wallet provider ID from the transaction message matches the PAN. For example, the e-wallet provider ID may be used to look up the PAN of the user in the PAN table. If the PAN in the transaction message matches the PAN found in the PAN table using the e-wallet provider ID, the process 400 may proceed to block 415. Otherwise, the process 400 may proceed to block 430 where the transaction may be declined.

At block 415 it may be determined whether the MCC in the transaction details matches an approved MCC. An MCC is a four-digit number assigned to a business by credit card companies. An approved MCC, for example, may be an MCC associated with a merchant associated with the PAN in the PAN-merchant table 250. Alternatively or additionally, an approved MCC may be an MCC value in an approved MCC table that includes the MCC values for each and every merchant associated with a virtual prepaid instrument. Alternatively or additionally, an approved MCC may be an MCC value in an approved MCC table that includes the MCC values for each and every participating merchant. If the MCC is not an approved MCC, then process 400 may proceed to block 430 where the transaction is declined. If it the MCC is an approved, then process 400 may proceed to block 420.

At block 420 it may be determined whether the merchant ID in the transaction details matches an approved merchant ID (MID). In some embodiments, a merchant may have a single unique merchant ID. In some embodiments, a merchant may have a plurality of different merchant IDs. In some embodiments, a merchant with multiple stores or locations may have a different or the same merchant ID for each store. In some embodiments, the merchant ID may be different for every transaction. In some embodiments, different merchant processors 135 may assign different merchant IDs to the same merchant 145. In some embodiments, the merchant ID may be a fixed length value.

If the merchant ID in the transaction details matches an approved merchant ID, then process 400 proceeds to block 435. Otherwise, the process 400 proceeds to block 425. At block 425, it may be determined whether the merchant in the transaction details matches an approved merchant description. Because a merchant may be associated with different merchant IDs it may be difficult to link a virtual prepaid instrument with a single merchant. The transaction details may include a merchant description such as, for example, the name of the merchant. This merchant description may be compared with other merchant descriptions and/or keywords associated with the merchant stored in a merchant table. In some embodiments, important merchant values may be extracted from the merchant description of the transaction details.

At block 435 it can be determined if there are funds available. For example, at block 435 a PAN-merchant table may be used to determine the available value associated with the virtual prepaid instrument. If the available value is greater than the transaction amount, then the transaction may be approved at block 440 otherwise the transaction may be declined at block 430. Regardless of the outcome, in some embodiments, a transaction message may be sent to the merchant 145, the merchant processor 135, and/or the acquiring bank 140.

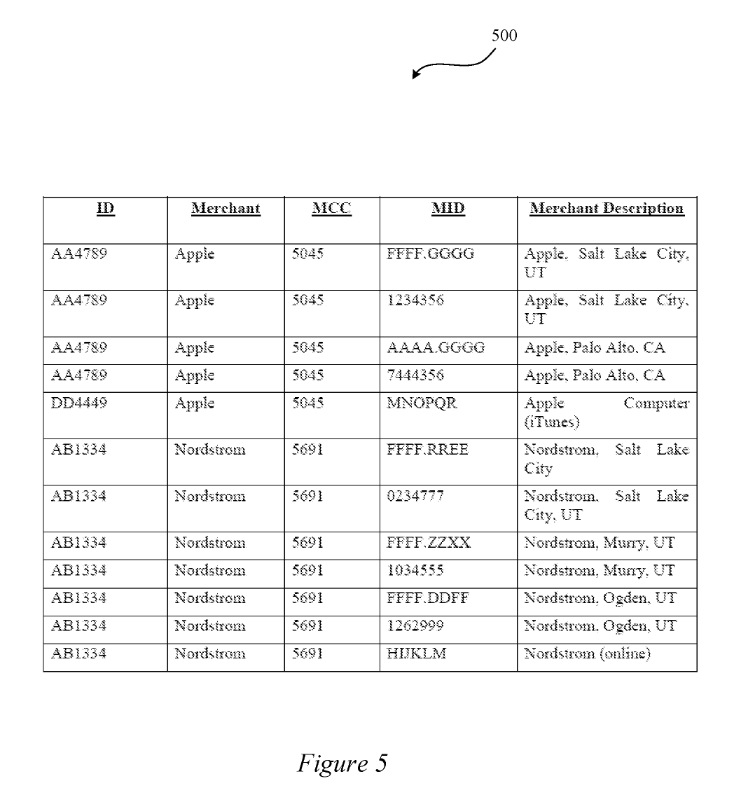

FIG. 5 illustrates an example merchant table 500. The merchant table 500 may include one or more columns associated with at least one or more virtual prepaid instrument IDs, merchant data, MCC data, MID data, virtual prepaid instrument IDs, and/or merchant description data. In some embodiments, a merchant may be associated with one or more virtual prepaid instrument IDs. In some embodiments, one or more merchants may be associated with a single virtual prepaid instrument ID. As shown in this example, in the merchant table 500 Apple is associated with two virtual prepaid instrument IDs. One virtual prepaid instrument ID is associated only with Apple iTunes while the other virtual prepaid instrument IDs are associated with retail stores.

As shown in this example, in the merchant table 500 Apple is also associated with a number of MIDs. The different MIDs, for example, may be the MID for different processors (e.g., one for a credit card processor and/or one for a debit card processor, etc.) and/or for different retail locations. In this example, Nordstrom is associated with a single virtual prepaid instrument ID and many different MIDs.

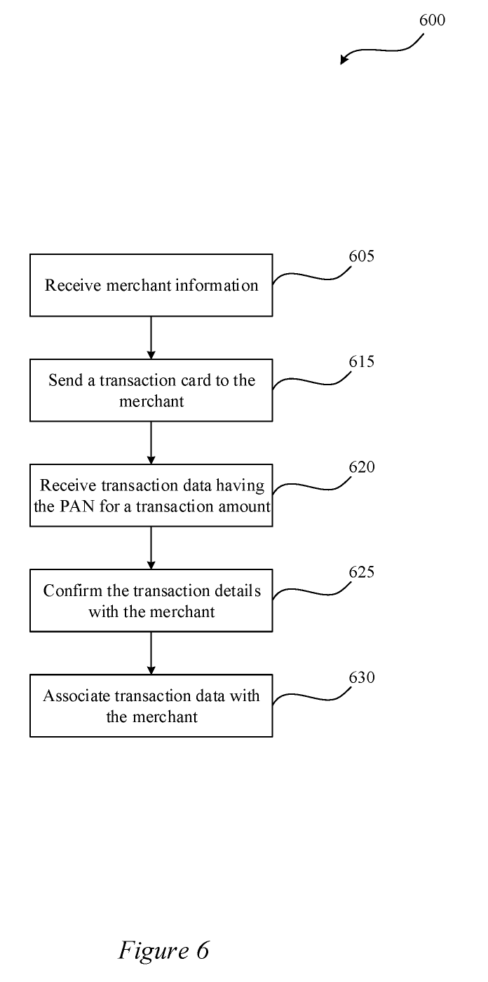

FIG. 6 is a flowchart of an example process 600 for collecting merchant information for use in a virtual prepaid instrument transaction. One or more steps of the process 600 may be implemented by a web server such as, for example, one associated with the virtual prepaid instrument distributor and/or the virtual prepaid instrument processor 120. Although illustrated as discrete blocks, various blocks may be divided into additional blocks, combined into fewer blocks, or eliminated, depending on the desired implementation.

A merchant desiring to participate in a virtual prepaid instrument program may enter information about the merchant such as, for example, through a webpage. The e merchant information may be received at block 605. The merchant information, for example, may include the merchant name; the merchant's contact information; merchant banking information; a graphic, logo, colors, icon, etc. for the virtual prepaid instrument; denomination information; etc.

In some embodiments, an account may be made for the merchant that includes the merchant information received from the merchant at block 605. In some embodiments, a virtual prepaid instrument may be created including the merchant information received at block 605 that may be communicated and/or stored at a virtual prepaid instrument holder's smart device. In some embodiments, a unique PAN may be created and associated with the merchant and or the merchant ID.

At block 615 the, in some embodiments, a transaction card that includes a bank identification number (BIN) associated with the virtual prepaid instrument processor may be sent to the merchant such as, for example, through the mail or an overnight delivery service. In some embodiments, a unique PAN may be created for each merchant. In some embodiments, a general PAN may be used. In some embodiments, one or more transaction cards may be used be used for different processors such as, for example, a credit card transaction card and or a debit card transaction card.

In some embodiments, a transaction may be initiated by the merchant using the transaction card with a specific transaction amount. At block 620 transaction data associated with this transaction may be received at the virtual prepaid instrument processor 120. Because the PAN is associated with data collection and includes a BIN that routes the transaction to the virtual prepaid instrument processor, the virtual prepaid instrument processor may recognize that the card is used to collect merchant information. In some embodiments more than one transaction may be received with different and/or unique transaction data.

At block 625 transaction details may be confirmed by contacting the merchant. For example, if the transaction indicated a transaction for $1.33, then the merchant may be contacted to confirm that the transaction card was used to make a transaction for $1.33. For example, if the transaction occurred on given date, then the merchant may be contacted to confirm that the transaction card was used to make a on that date. In some embodiments, block 625 may be skipped.

At block 630, the transaction data received at block 620 may be associated with the merchant. For example, the MID, MCC, and/or merchant details received as part of the transaction data may be associated with the merchant. In some embodiments, a PAN-table may be created or a PAN-table may be updated with the transaction data.

In some embodiments the process 600 may be repeated a number of times at a number of different merchant locations, using different acquirer processors, using different terminals at the merchant, and/or through the merchant's online marketplace, etc., to capture the different MIDs used by the merchant and/or the different information provided in the merchant description.

In some embodiments, blocks 620, 625, and 630 may be repeated any number of times. For example, a merchant 145 may execute a transaction using the PAN any number of times using different terminals, at different merchant locations, through different merchant processors 135, with different transaction amounts, with card not present transactions, as a debit card transaction, as a credit card transaction, etc. By repeating these blocks a number of times, a merchant table (e.g., merchant table 500) may be created and/or updated that associates merchants with merchant data (e.g., MCC, MID, and/or merchant description) that may vary depending on any number of transaction variables.

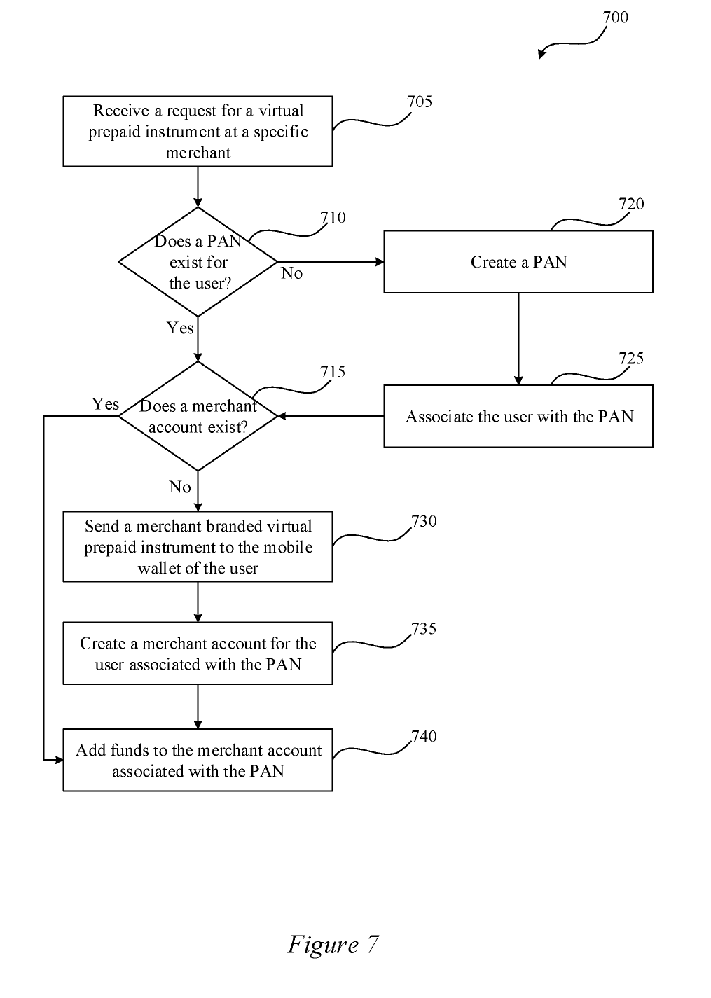

FIG. 7 is a flowchart of an example process 700 for creating a merchant branded virtual prepaid instrument. One or more steps of the process 700 may be implemented, in some embodiments, by one or more components of system 100 of FIG. 1A, such as the virtual prepaid instrument distributor, the virtual prepaid instrument processor 120, and/or a web server associated with the merchant 145. Although illustrated as discrete blocks, various blocks may be divided into additional blocks, combined into fewer blocks, or eliminated, depending on the desired implementation.

At block 705 a request for a virtual prepaid instrument for a specific merchant may be received from a user. The request may be received through a webpage or sent from a webserver to the virtual prepaid instrument processor 120 and/or the virtual prepaid instrument distributor and/or the merchant 145. In some embodiments the request may include a PAN associated with the user or the user's smart device and/or mobile wallet. In some embodiments, the request may include a phone number, a username, password, and/or other information identifying the user. In some embodiments, the request may include information identifying the merchant such as, for example, the merchant name, a code specifying the merchant, a virtual prepaid instrument ID, a virtual prepaid instrument value, and/or other information identifying the merchant. In some embodiments the virtual prepaid instrument holder 105 may make the request using a smart device and or through a mobile wallet on the smart device. In some embodiments the mobile wallet may be part of the smart device's operating system or it may be a standalone application executing on the smart device.

In some embodiments the request for the virtual prepaid instrument from the merchant may be made in response to an advertisement made by the merchant.

At block 710 if the user is already associated with a PAN, then process 700 proceeds to block 715. If the user is not associated with a PAN, then the process proceeds to block 720.

At block 720 a PAN may be created for the user. The user can be associated with the PAN at block 725. In some embodiments, a PAN table may be updated or created with the user information and the PAN.

At block 715 it can be determined whether a merchant account exists for the merchant identified in the request received at block 705. For example, it may be determined whether the merchant is associated with a virtual prepaid instrument ID. In some embodiments, the request may include a virtual prepaid instrument ID, which, in some embodiments, may allow for block 715 to be skipped.

At block 730 a merchant branded virtual prepaid instrument may be created and sent to the mobile wallet of the user. In some embodiments, the merchant branded virtual prepaid instrument sent to the mobile wallet may include icons, graphics, images, text, etc. associated with the merchant. In some embodiments, the merchant branded virtual prepaid instrument sent to the mobile wallet may include text specifying the value associated with the virtual prepaid instrument.

At block 735, a merchant account may be created for the user associated with the PAN at the virtual prepaid instrument processor 120 and/or the virtual prepaid instrument distributor. Alternatively and/or additionally, the mobile device may include a table associating a virtual prepaid instrument ID, the PAN, and/or the merchant together. Additionally or alternatively, the second user's smart device may include a table associating a virtual prepaid instrument ID, the PAN, and/or the merchant together. At block 740 the funds specified in the request may be added to the account. In some embodiments, a transaction settlement may occur to settle payment for the virtual prepaid instrument.

As the user uses the virtual prepaid instrument the value in the table may be decremented. In addition, the user may add value to the virtual prepaid instrument, which may result in an increase in the value listed in the table.

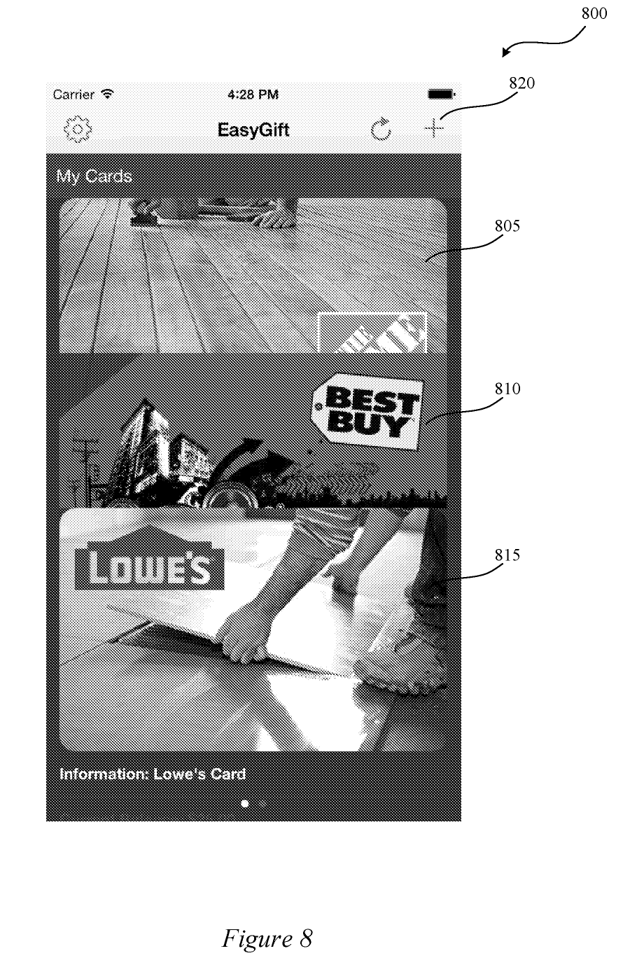

FIG. 8 illustrates an example screenshot of a mobile wallet 800 that includes a plurality of virtual prepaid instruments. In this example, three virtual prepaid instruments are presented: virtual prepaid instrument 805 associated with the Home Depot, virtual prepaid instrument 810 associated with Best Buy, and virtual prepaid instrument 815 associated with Lowe's. As shown in the figure, each virtual prepaid instrument includes an image, an icon, and/or text specifying the merchant associated with the virtual prepaid instrument. Each of the virtual prepaid instruments 805, 810, and 815 may be associated with a single PAN, yet may only be used with the specific merchant associated with the virtual prepaid instrument.

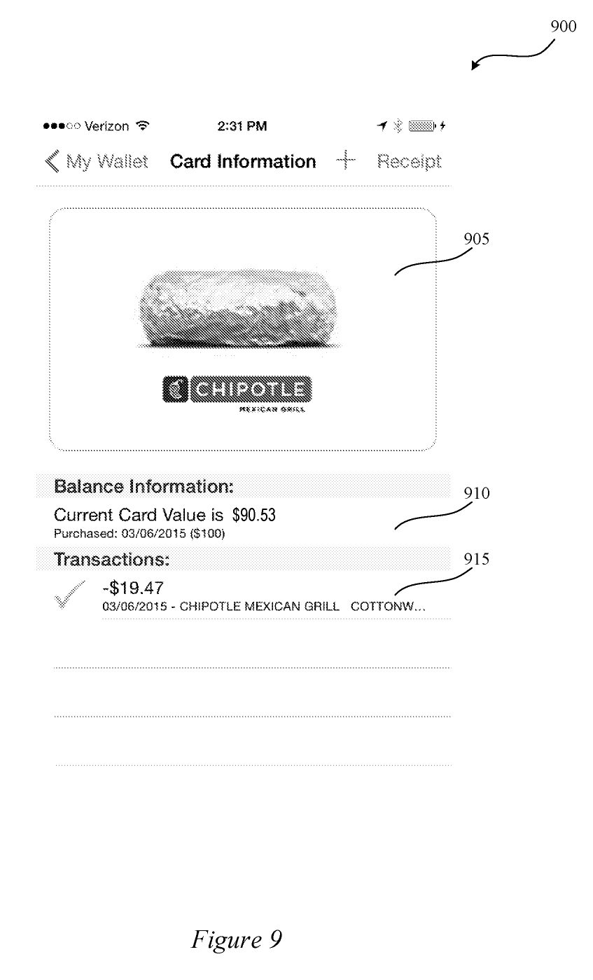

A user may select one of the virtual prepaid instruments by tapping on the image, icon and/or text. Once selected, the mobile wallet 800 may present a virtual prepaid instrument as shown in FIG. 9.

The mobile wallet 800 may also include a button that may be pressed to purchase a virtual prepaid instrument. In this example, the button is a graphical representation of a plus sign 820. When the button is pushed, the user may be presented with a marketplace of virtual prepaid instruments that may be selected and/or purchased through the mobile wallet.

FIG. 9 illustrates an example screenshot of a virtual prepaid instrument 900 for the merchant Chipotle. In this example, the virtual prepaid instrument includes graphics 905 associated with the merchant. The graphics 905 may include an image, an icon, and/or text. The virtual prepaid instrument may also include a value 910 associated with the virtual prepaid instrument. In some embodiments, the virtual prepaid instrument may include a representation of a current card value 910 that shows the balance of available funds on the virtual prepaid instrument. In some embodiments the virtual prepaid instrument may include a listing of transactions 915 that have been previously executed with the virtual prepaid instrument. These previously executed transactions may include a history of transactions. In some embodiments, the virtual prepaid instrument may display the value of the virtual prepaid instrument when it was purchased.

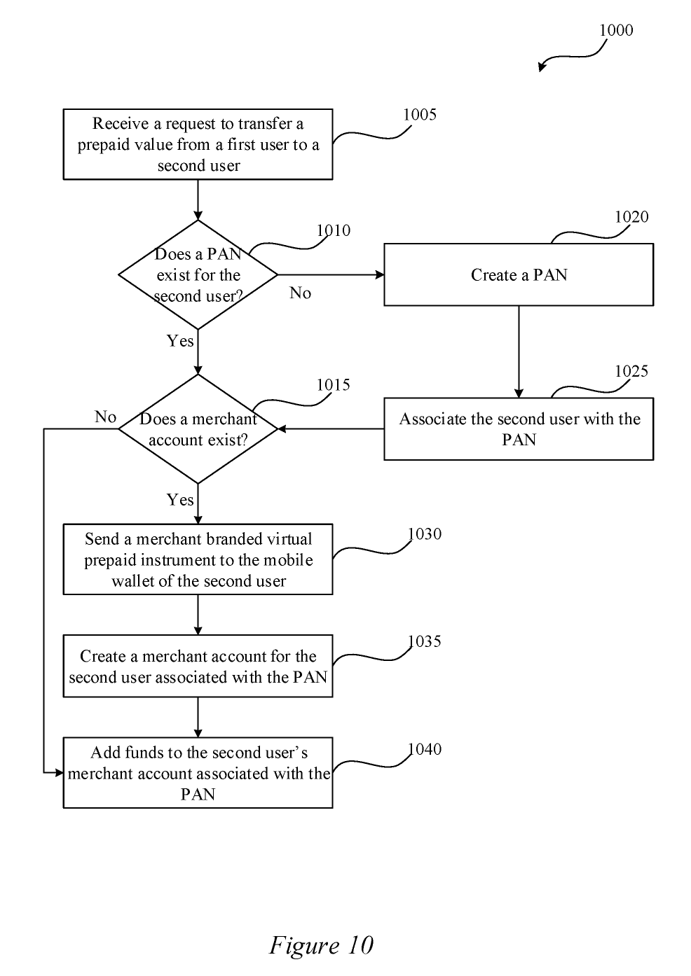

FIG. 10 is a flowchart of an example process 1000 for transferring a specific value from merchant branded virtual prepaid instruments held by a first user to a second user. One or more steps of the process 1000 may be implemented, in some embodiments, by one or more components of system 100 of FIG. 1A, such as the virtual prepaid instrument distributor, the virtual prepaid instrument processor 120, and/or a web server associated with the merchant 145. Although illustrated as discrete blocks, various blocks may be divided into additional blocks, combined into fewer blocks, or eliminated, depending on the desired implementation.

At block 1005 a request for transferring a virtual prepaid instrument value for a specific merchant from a first user to a second user may be received from the first user. The request may be received through a webpage or sent from a webserver to the virtual prepaid instrument processor 120 and/or the virtual prepaid instrument distributor and/or the merchant 145. In some embodiments the request may include a PAN associated with the first user or the first user's smart device and/or mobile wallet. In some embodiments, the request may include a phone number, a username, password, the specific value, a PAN associated with the second user, and/or other information identifying the first user and/or the second user. In some embodiments, the request may include information identifying the merchant such as, for example, the merchant name, a code specifying the merchant, a virtual prepaid instrument ID, a virtual prepaid instrument value, and/or other information identifying the merchant. In some embodiments the virtual prepaid instrument holder 105 may make the request using a smart device and or through a mobile wallet on the smart device. In some embodiments the mobile wallet may be part of the smart device's operating system or it may be a standalone application executing on the smart device.

At block 1010 it can be determined whether the second user is associated with a PAN such as, for example, by looking up the user in a PAN table (e.g., PAN table 200 shown in FIG. 2A). In some embodiments, if the second user is associated with a PAN, then process 1000 proceeds to block 1015. If the second user is not associated with a PAN, then the process proceeds to block 1020.

At block 1020 a PAN may be created for the second user. The second user can be associated with the PAN at block 1025, such as, for example, in a PAN table.

At block 1015 it can be determined whether the second user has a merchant account for the merchant identified in the request received at block 1005. For example, using a PAN-merchant table it may be determined whether the second user is associated with a prepaid account at the merchant by looking up the PAN of the second user and determining whether the merchant exists in the table for the PAN.

At block 1030 a merchant branded virtual prepaid instrument may be created and sent to the mobile wallet of the second user. In some embodiments, the merchant branded virtual prepaid instrument sent to the mobile wallet of the second user may include icons, graphics, images, text, etc., associated with the merchant. In some embodiments, the merchant branded virtual prepaid instrument sent to the mobile wallet of the second user may include text specifying the value associated with the virtual prepaid instrument.

At block 1035, a merchant account may be created for the second user associated with the PAN at the virtual prepaid instrument processor 120 and/or the virtual prepaid instrument distributor. Alternatively and/or additionally, the mobile device may include a table associating a virtual prepaid instrument ID, the PAN, and/or the merchant together. Additionally or alternatively, the user's smart device may include a table associating a virtual prepaid instrument ID, the PAN, and/or the merchant together. At block 1040 the funds specified in the request may be added to the second user's account and decremented form the first user's account. In some embodiments, a transaction settlement may occur to settle the transfer of funds between user accounts.

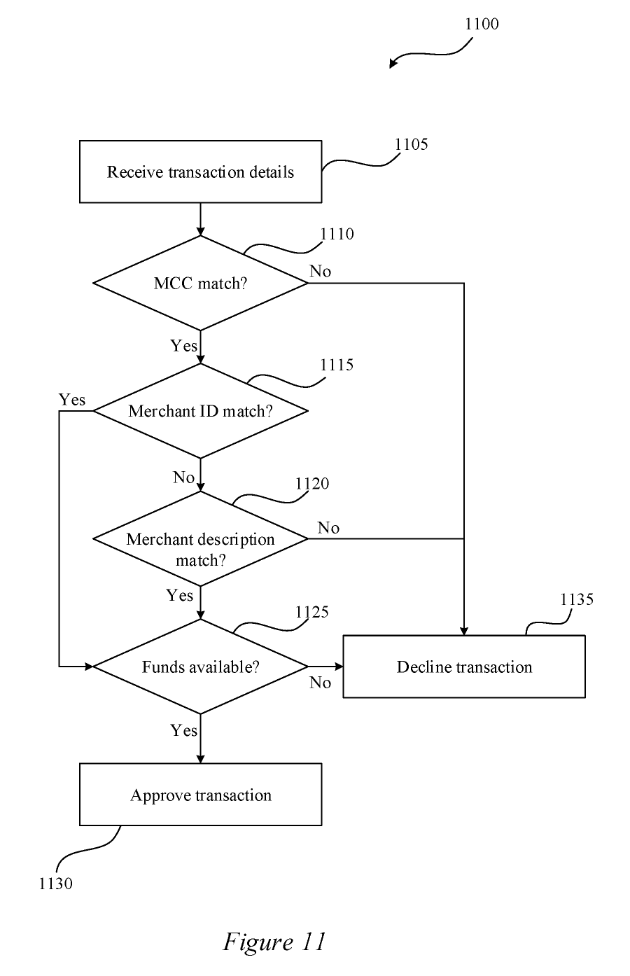

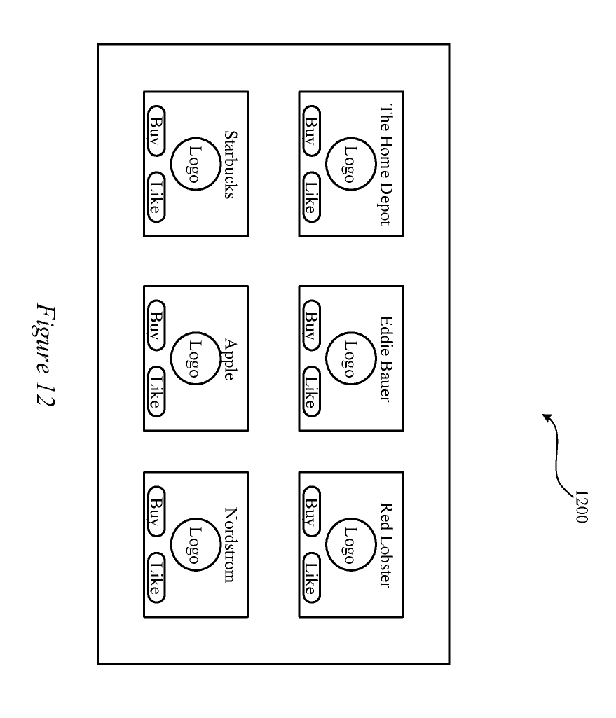

FIG. 11 is a flowchart of an example process 1100 for authorizing a virtual prepaid instrument transaction. One or more steps of the process 1100 may be implemented, in some embodiments, by one or more components of system 100 of FIG. 1A, such as the virtual prepaid instrument distributor, the virtual prepaid instrument processor 120, and/or a web server associated with the merchant 145. Although illustrated as discrete blocks, various blocks may be divided into additional blocks, combined into fewer blocks, or eliminated, depending on the desired implementation.

At block 1105, transaction details (e.g., in a transaction message) may be received at the virtual prepaid instrument processor 120. The transaction details may include, for example, a transaction amount, a PAN, a merchant category code (MCC), a merchant ID (MID), a merchant description, etc.

At block 1110 it can be determined whether the merchant category code matches a merchant category code in a database of approved merchant category codes. Merchants may have a unique merchant category code depending on the type of business operated by the merchant. An approved merchant category code database may exist that includes the merchant category codes for merchants that are associated with a virtual prepaid instrument. If the merchant category code does not match a merchant category code in the database of approved merchant category codes, then process 1100 proceeds to block 1135 where the transaction is declined. Otherwise, the process 1100 proceeds to block 1115.

At block 1115 it can be determined whether the merchant ID matches a merchant ID in a database of approved merchant IDs. Merchants may have one or more unique merchant IDs depending on any number of factors. An approved merchant ID database may exist that includes the merchant ID for merchants that are associated with a virtual prepaid instrument. If the merchant ID does not match an approved merchant ID in the database of approved merchant IDs, then process 1100 proceeds to block 1120 where the transaction is declined. Otherwise, the process 1100 proceeds to block 1125.

At block 1120 it can be determined whether the merchant description matches a merchant description or a keyword of a merchant description in a database of approved merchant descriptions. Merchants may have one or more unique merchant descriptions based on any number of factors. An approved merchant description database may exist that includes the merchant description or keywords for merchants that are associated with a virtual prepaid instrument. If the merchant description does not match an approved merchant description, then process 1100 proceeds to block 1125. Otherwise, the process 1100 proceeds to block 1135.

At block 1125 it can be determined if there are funds available. For example, at block 1125 a PAN-merchant table may be used to determine the available value on the virtual prepaid instrument. If the available value is greater than the transaction amount, then the transaction may be approved at block 1130 otherwise the transaction may be declined at block 1135. Regardless of the outcome, in some embodiments, a transaction message may be sent to the merchant 145, the merchant processor 135, and/or the acquiring bank 140 indicating the status of the transaction and/or for settlement purposes.

FIG. 12 is a block diagram of an example marketplace 1200. In this example, six virtual prepaid instruments are displayed that may be viewed, purchased or favorited by a user. Each virtual prepaid instrument may include a name of the merchant, one or more logos or graphics, a “buy” button, and/or a “like” button. For example, a first user may purchase one of the virtual prepaid instruments for by selecting the “Buy” button. For example, a first user may favorite one of the virtual prepaid instruments by selecting the “Like” button. When a virtual prepaid instrument has been favorited, a second user can look up the first user via a username, name, code, link, or other identifier to discover which virtual prepaid instruments the first user is interested in. The second user may then purchase the virtual prepaid instrument on behalf of the first user.

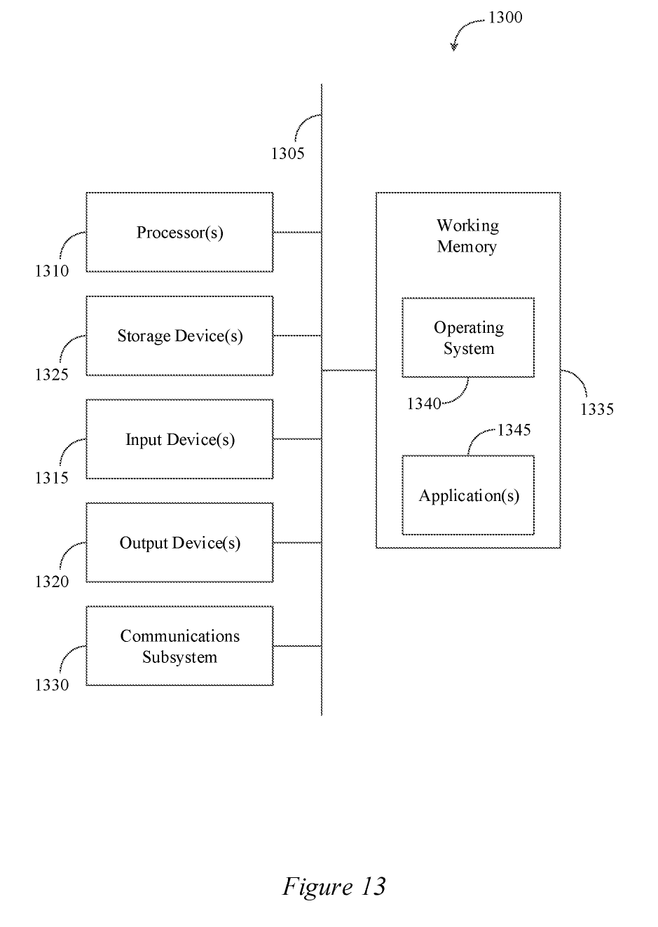

The computational system 1300 (or processing unit) illustrated in FIG. 13 can be used to perform and/or control operation of any of the embodiments described herein. For example, the computational system 1300 can be used alone or in conjunction with other components. As another example, the computational system 1300 can be used to perform any calculation, solve any equation, perform any identification, and/or make any determination described herein.

The computational system 1300 may include any or all of the hardware elements shown in the figure and described herein. The computational system 1300 may include hardware elements that can be electrically coupled via a bus 1305 (or may otherwise be in communication, as appropriate). The hardware elements can include one or more processors 1310, including, without limitation, one or more general-purpose processors and/or one or more special-purpose processors (such as digital signal processing chips, graphics acceleration chips, and/or the like); one or more input devices 1315, which can include, without limitation, a mouse, a keyboard, and/or the like; and one or more output devices 1320, which can include, without limitation, a display device, a printer, and/or the like.

The computational system 1300 may further include (and/or be in communication with) one or more storage devices 1325, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 1300 might also include a communications subsystem 1330, which can include, without limitation, a modem, a network card (wireless or wired), an infrared communication device, a wireless communication device, and/or chipset (such as a Bluetooth® device, an 802.6 device, a WiFi device, a WiMAX device, cellular communication facilities, etc.), and/or the like. The communications subsystem 1330 may permit data to be exchanged with a network (such as the network described below, to name one example) and/or any other devices described herein. In many embodiments, the computational system 1300 will further include a working memory 1335, which can include a RAM or ROM device, as described above.

The computational system 1300 also can include software elements, shown as being currently located within the working memory 1335, including an operating system 1340 and/or other code, such as one or more application programs 1345, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 1325 described above.

In some cases, the storage medium might be incorporated within the computational system 1300 or in communication with the computational system 1300. In other embodiments, the storage medium might be separate from the computational system 1300 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 1300 and/or might take the form of source and/or installable code, which, upon compilation and/or installation on the computational system 1300 (e.g., using any of a variety of generally available compilers, installation programs, compression/decompression utilities, etc.), then takes the form of executable code.

The term “substantially” means within 5% or 10% of the value referred to or within manufacturing tolerances.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

That which is claimed:

1. A method comprising:
receiving a transaction message from a merchant through an open-loop financial transaction network, wherein the transaction message includes data elements comprising a primary account number, a transaction amount, a merchant ID, a merchant description, and a merchant category code;
looking up the primary account number in a database of primary account numbers;
determining whether the primary account number is associated with a virtual prepaid instrument of the merchant based on whether the database associates the primary account number with at least one of the merchant ID, the merchant description, and the merchant category code;
in the event that the primary account number is associated with a virtual prepaid instrument with the merchant, determining whether the transaction amount is less than an available value amount of the virtual prepaid instrument associated with the primary account number in the database; and
in the event that the transaction amount is less than an available value amount of the virtual prepaid instrument, sending a transaction authorization message response to the merchant through an open-loop financial transaction network.

2. The method according to claim 1, wherein the open-loop financial transaction network comprises a multiparty financial transaction network.

3. The method according to claim 1, wherein the database of primary account numbers includes at least one primary account number associated with two or more merchants.

4. The method according to claim 1, wherein the determining whether the primary account number is associated with a virtual prepaid instrument associated with the merchant based on at least one of the merchant ID, the merchant description, and the merchant category code, further comprises determining whether the primary account number is associated with a virtual prepaid instrument associated with the merchant based on each of the merchant ID, the merchant description, and the merchant category code.

5. The method according to claim 1, wherein the determining whether the primary account number is associated with a virtual prepaid instrument associated with the merchant based on at least one of the merchant ID, the merchant description, and the merchant category code, further comprises determining whether the merchant category code matches an approved merchant category code.

6. The method according to claim 1, wherein the determining whether the primary account number is associated with a virtual prepaid instrument associated with the merchant based on at least one of the merchant ID, the merchant description, and the merchant category code, further comprises determining whether the merchant ID matches an approved merchant ID.

7. The method according to claim 1, wherein the determining whether the primary account number is associated with a virtual prepaid instrument associated with the merchant based on at least one of the merchant ID, the merchant description, and the merchant category code, further comprises determining whether the merchant description includes at least one keyword that matches one or more approved merchant keywords.

8. The method according to claim 1, further comprising:
settling the transaction with the merchant; and
decrementing the transaction amount from the virtual prepaid instrument associated with the primary account number.

9. A transaction processing system comprising:
a database comprising a plurality of primary account numbers, each primary account number associated with merchant data associated with one or more merchants;
a network interface coupled with an open-loop financial transaction network; and
a processor coupled with the database and the network interface, the processor configured to:
receive a transaction message from a merchant through the open-loop financial transaction network via the network interface, wherein the transaction message includes data elements comprising a first primary account number, a transaction amount, and merchant data;
determine whether the first primary account number matches a primary account number of the plurality of primary account numbers in the database;
determine whether the first primary account number is associated with a virtual prepaid instrument of the merchant based on the merchant data associated with the first primary account number in the database;
in the event that the primary account number is associated with a virtual prepaid instrument of the merchant, determine whether the transaction amount is less than an available value amount of the virtual prepaid instrument associated with the primary account number in the database; and
in the event that the transaction amount is less than an available value amount of the virtual prepaid instrument, send a transaction authorization message response to the merchant through the open-loop financial transaction network.

10. The transaction processing system according to claim 9, wherein the open-loop financial transaction network comprises a multiparty financial transaction network.

11. The transaction processing system according to claim 9, wherein the database includes at least one primary account number associated with two or more merchants.

12. The transaction processing system according to claim 9, wherein the merchant data includes one or more of a merchant ID, a merchant description, and a merchant category code.

13. The transaction processing system according to claim 9, wherein to determine whether the primary account number is associated with a virtual prepaid instrument associated with the merchant based on the merchant data, the processor is further configured to determine whether the primary account number is associated with a virtual prepaid instrument associated with the merchant based on each of the merchant data.

14. The transaction processing system according to claim 9, wherein to determine whether the primary account number is associated with a virtual prepaid instrument associated with the merchant based on the merchant data, the processor is further configured to determine whether the merchant category code matches an approved merchant category code.

15. The transaction processing system according to claim 9, wherein to determine whether the primary account number is associated with a virtual prepaid instrument associated with the merchant based on the merchant data, the processor is further configured to determine whether the merchant ID matches an approved merchant ID.

16. The transaction processing system according to claim 9, wherein to determine whether the primary account number is associated with a virtual prepaid instrument associated with the merchant based on the merchant data, the processor is further configured to determine whether the merchant description includes at least one keyword that matches one or more approved merchant keywords.

17. The transaction processing system according to claim 9, wherein the processor is further configured to:
settle the transaction with the merchant; and
decrement the transaction amount from the virtual prepaid instrument associated with the primary account number and the merchant.

18. A method comprising:
receiving at a virtual prepaid instrument processor a transaction message from a merchant through an open-loop financial transaction network, wherein the transaction message includes data elements comprising a primary account number, a transaction amount, a merchant ID, and a merchant category code;
determining whether the merchant category code corresponds with an approved merchant category code;
determining whether the merchant ID corresponds with an approved merchant ID;
determining whether the primary account number and the merchant ID are associated with a virtual prepaid instrument;
determining a value associated with the primary account number and the merchant;
determining whether the transaction amount is less than the value; and
sending a transaction authorization message response to the merchant through an open-loop financial transaction network.

19. The method according to claim 18, wherein the data elements comprise a merchant description; and the method further comprises:
determining whether the merchant description corresponds with a merchant description associated with a merchant.

20. The method according to claim 18, further comprising:
settling the transaction with the merchant; and
decrementing the transaction amount from the virtual prepaid instrument associated with the primary account number and the merchant.

21. The method according to claim 18, wherein the open-loop financial transaction network comprises a multiparty financial transaction network.

22. The method according to claim 18, wherein the database of primary account numbers includes at least one primary account number associated with two or more merchants.
